(19) United States
(12) Patent Application Publication
(10) Pub. No.: US 2017/0139469 A1
(43) Pub. Date: May 18, 2017

(54) POWER-MINIMIZING VOLTAGE RAIL SELECTION IN A PORTABLE COMPUTING DEVICE

(71) Applicant: QUALCOMM INCORPORATED, SAN DIEGO, CA (US)

(72) Inventors: RICHARD STEWART, San Diego, CA (US); Dexter Tamio Chun, San Diego, CA (US); Alain Artieri, San Diego, CA (US)

(21) Appl. No.: 14/940,065

(22) Filed: Nov. 12, 2015

(51) Int. Cl. G06F 1/32

(52) U.S. Cl. CPC G06F 1/3296; G06F 1/3287

(57) ABSTRACT

Components of a portable computing device produce power supply voltage requests indicating requested power levels. In response to the power supply voltage requests, power multiplexers associated with the components select and couple corresponding voltage rails associated with two or more fixed-voltage power supplies to the requesting components. Power supplies may be activated and deactivated on an as-requested basis.

### DESCRIPTION OF THE RELATED ART

Portable computing devices (“PCDs”) are becoming necessities for people on personal and professional levels. These devices may include cellular telephones, portable digital assistants, portable game consoles, palmtop computers, and other portable electronic elements.

A PCD has various electronic components that consume power, such as one or more cores of a system-on-chip (“SOC”). Cores may include, for example, central processing units (“CPUs”), graphics processing units (“GPUs”), digital signal processors (“DSPs”) and memory systems.

The speed at which a PCD component operates may be increased or decreased in response to the clock frequency and the power supply voltage applied to it. Applying a higher-speed clock and, accordingly, a higher power supply voltage to a PCD component generally results in higher-speed operation but consumes more power. As power conservation is desirable in battery operated PCDs, schemes have been developed to balance PCD performance with power consumption. For example, a resource power manager (“RPM”) may monitor operating conditions in the PCD. When the RPM detects operating conditions that would undesirably impact performance, the RPM may generate an indication that power supplied to one or more components should be increased to maintain performance. A PCD may include one or more scalable-voltage or adjustable power supplies that the RPM may adjust to output a selected voltage.

In some PCDs, each component sharing a voltage rail may issue a message or signal, commonly referred to as a “vote,” indicating a desired voltage level. An RPM may receive votes from the components sharing a power rail and adjust the power supply on that rail to set the voltage to the highest voltage level among those indicated by the received votes. This solution may not be optimal because those components that did not vote for that highest voltage level will consume more power than necessary.

### SUMMARY OF THE DISCLOSURE

Systems, methods, and computer program products are disclosed for power control in a portable computing device (“PCD”). In an exemplary method, each of a plurality of PCD components produces one of a plurality of power supply voltage requests. Each power supply voltage request indicates one of a plurality of selectable power levels and corresponds to one of a plurality of fixed-voltage power supplies. Each of a plurality of power multiplexers receives a control signal in response to one of the power supply voltage requests. A selected voltage produced by one of the fixed-voltage power supplies is coupled through each of the plurality of power multiplexers to a corresponding PCD component in response to the control indication.

An exemplary system includes a plurality of PCD components, a plurality of fixed-voltage power supplies, and a plurality of power multiplexers. Each PCD component is configured to produce one of a plurality of power supply voltage requests. Each fixed-voltage power supply is configured to produce a different voltage. Each power supply voltage request indicates one of a plurality of selectable power levels and corresponds to one of the fixed-voltage power supplies. Each power multiplexer is coupled to a corresponding one of the PCD components and coupled to each of the fixed-voltage power supplies. Each power multiplexer is configured to receive a control signal in response to one of the power supply voltage requests. Each power multiplexer is also configured to couple a selected voltage produced by one of the plurality of fixed-voltage power supplies to a corresponding PCD component in response to the control signal.

### BRIEF DESCRIPTION OF THE DRAWINGS

In the Figures, like reference numerals refer to like parts throughout the various views unless otherwise indicated. For reference numerals with letter character designations such as “102A” or “102B”, the letter character designations may differentiate two like parts or elements present in the same Figure. Letter character designations for reference numerals may be omitted when it is intended that a reference numeral to encompass all parts having the same reference numeral in all Figures.

FIG. 1 is a block diagram of a system for power control in a PCD, in accordance with an exemplary embodiment.

FIG. 2 is a block diagram of another system for power control in a PCD, in accordance with another exemplary embodiment.

FIG. 3 is a block diagram of still another system for power control in a PCD, in accordance with still another exemplary embodiment.

FIG. 4 is a block diagram of yet another system for power control in a PCD, in accordance with yet another exemplary embodiment.

FIG. 5 is a block diagram of another system for power control in a PCD, in accordance with yet another exemplary embodiment.

FIG. 6 is a flow diagram illustrating a method for power control in a PCD, in accordance with an exemplary embodiment.

FIG. 7 is a block diagram of a PCD, in accordance with an exemplary embodiment.

### DETAILED DESCRIPTION

The word “exemplary” is used herein to mean “serving as an example, instance, or illustration.” Any aspect described herein as “exemplary” is not necessarily to be construed as preferred or advantageous over other aspects.

In this description, the term “portable computing device” (“PCD”) is used to describe any computing device operating on a limited-capacity power supply, such as a battery. Although battery operated PCDs have been in use for decades, technological advances in rechargeable batteries coupled with the advent of third generation (“3G”) and fourth generation (“4G”) wireless technology have enabled numerous PCDs with multi-faceted capabilities. Therefore, the term “PCD” may encompass a cellular telephone (e.g., a smartphone), a satellite telephone, a pager, a PDA, a navigation device, a smartbook or reader, a media player, a laptop or hand-held computer with a wireless connection, or a combination of the aforementioned devices, among others.

The terms “central processing unit” (“CPU”), “digital signal processor” (“DSP”), and “graphics processing unit” (“GPU”) are non-limiting examples of processors that may reside in a PCD. In the context of system-on-chip (“SOC”) architectures, a processor may be a “core.” These terms are used interchangeably in this specification except where otherwise indicated. The term “PCD component” is used in this specification to refer to a processor, core or other electronic component of a PCD that has power supply usage and control characteristics similar to those described below with regard to exemplary embodiments.

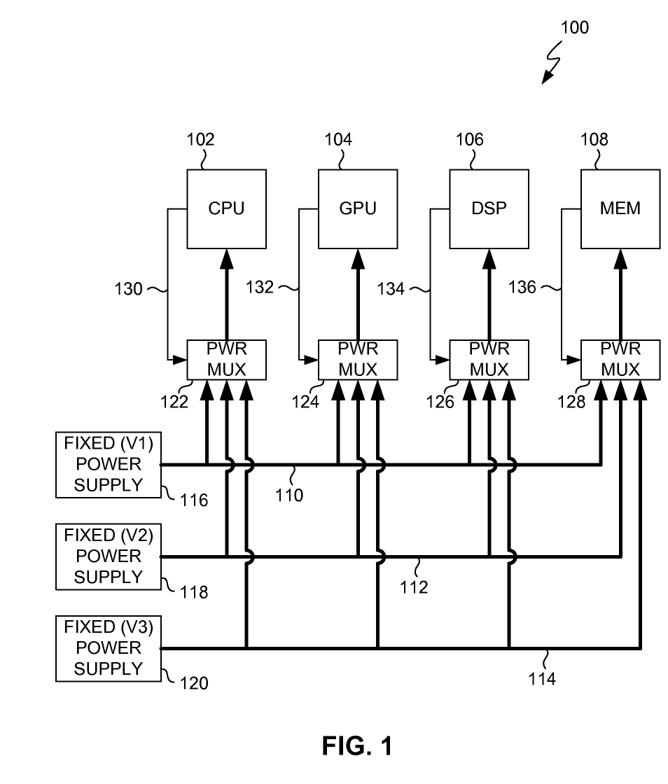

As illustrated in FIG. 1, in an illustrative or exemplary embodiment, a system 100 for PCD power control includes a group of exemplary PCD components: a CPU 102, a GPU 104, a DSP 106, and a memory system 108. Although this exemplary embodiment includes four PCD components for illustrative purposes, other embodiments may include any other number of two or more PCD components. Each of these four exemplary PCD components may receive power from a selected one of three exemplary voltage rails 110, 112 and 114. As understood by one of ordinary skill in the art, the term “voltage rail” is used to encompass one or more power distribution elements, such as conductors, that route electrical current to power-consuming devices in a chip or other electronic system.

System 100 also includes a first fixed-voltage power supply 116 that produces current at a first fixed voltage (“V1”) on voltage rail 110, a second fixed-voltage power supply 118 that produces current at a second fixed voltage (“V2”) on voltage rail 112, and a third fixed-voltage power supply 120 that produces current at a third fixed voltage (“V3”) on voltage rail 114. The term “fixed-voltage” means that the voltage is controlled so as to remain substantially constant across an operational range of battery voltage and loading. Although this exemplary embodiment includes three fixed-voltage power supplies 116-120, other embodiments may include any other number of such power supplies.

System 100 further includes power multiplexers 122, 124, 126 and 128. In this exemplary embodiment, power multiplexers 122-128 are 3:1 multiplexers, meaning that each has three power inputs and one power output. Nevertheless, in other embodiments such power multiplexers may have any other number of inputs. The power output of each of power multiplexers 122-128 is coupled to a power input of a corresponding PCD component. The power inputs of each of power multiplexers 122-128 are coupled to each of fixed-voltage power supplies 116-120 through voltage rails 110-114. More specifically, a first power input of power multiplexer 122 is coupled to voltage rail 110, a second power input of power multiplexer 122 is coupled to voltage rail 112, and a third power input of power multiplexer 122 is coupled to voltage rail 114. Similarly, a first power input of power multiplexer 124 is coupled to voltage rail 110, a second power input of power multiplexer 124 is coupled to voltage rail 112, and a third power input of power multiplexer 124 is coupled to voltage rail 114. Also, a first power input of power multiplexer 126 is coupled to voltage rail 110, a second power input of power multiplexer 126 is coupled to voltage rail 112, and a third power input of power multiplexer 126 is coupled to voltage rail 114. Likewise, a first power input of power multiplexer 128 is coupled to voltage rail 110, a second power input of power multiplexer 128 is coupled to voltage rail 112, and a third power input of power multiplexer 128 is coupled to voltage rail 114.

Each PCD component may produce a power supply voltage request. The power supply voltage request may comprise a signal, message, or other indication that indicates a selected one of a number of selectable power levels. The selectable power levels correspond to the above-described voltages or voltage levels, such as V1, V2 and V3 in the embodiment illustrated in FIG. 1. Thus, in this embodiment a power supply voltage request also corresponds to one of fixed-voltage power supplies 116-120.

As the manner in which a PCD component may select or determine its own desired operating voltage or power level is well understood to one of ordinary skill in the art, this aspect is not described in further detail in this specification. It is sufficient for purposes of this specification to appreciate that each PCD component has this capability and that its selected or desired operating voltage or power level is represented by the above-referenced power supply voltage request. It should also be understood that a characteristic of a PCD component in the embodiments described in this specification is that the PCD component is programmed or otherwise configured with an algorithm or similar logic that provides the intelligence for selecting or determining its own desired operating voltage or power level. As such algorithms or logic are well understood by one of ordinary skill in the art, they are not described in this specification.

Each of power multiplexers 122-128 also has a control or selector input. In the embodiment illustrated in FIG. 1, the control input of each of power multiplexers 122-128 receives a corresponding control signal 130, 132, 134 and 136, respectively, in response to one of the power supply voltage requests. In the embodiment illustrated in FIG. 1, power multiplexers 122-128 receive control signals 130-136 directly from the corresponding PCD components, i.e., CPU 102, GPU 104, DSP 106, and memory system 108, respectively. In other words, in this embodiment each PCD component produces a control signal 130-136 in response to its power supply voltage request. Power supply voltage requests are not shown in FIG. 1, as they are represented by signals, messages or other indications internal to the PCD components.

In response to the control signals 130-136 received at their respective selector or control inputs, each of power multiplexers 122-128 selects one of voltage rails 110-114. Accordingly, the current and voltage characteristics supplied by a selected one of voltage rails 110-114 are coupled through the selecting one of power multiplexers 122-128 to the power input of the corresponding PCD component. Each PCD component that is selectively coupled to one of voltage rails 110-114 in this manner thus draws current through a selected one of voltage rails 110-114 and, correspondingly, from a selected one of fixed-voltage power supplies 116-120.

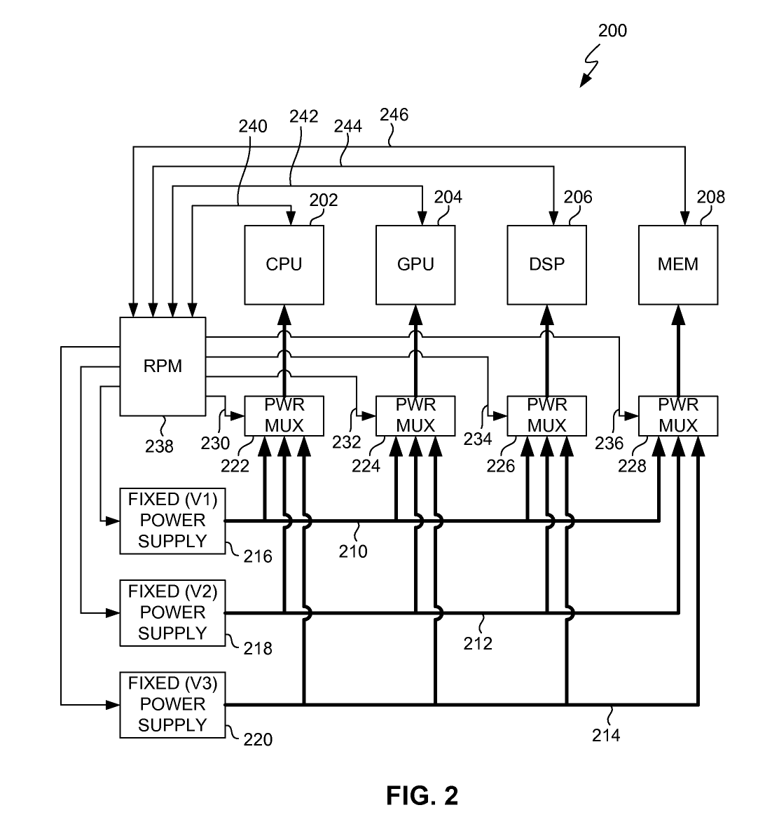

As illustrated in FIG. 2, in another illustrative or exemplary embodiment, a system 200 for PCD power control includes a group of exemplary PCD components: a CPU 202, a GPU 204, a DSP 206, and a memory system 208. Although this exemplary embodiment includes four PCD components for illustrative purposes, other embodiments may include any other number of two or more PCD components. Each of these four exemplary PCD components may receive power from a selected one of three exemplary voltage rails 210, 212 and 214.

System 200 also includes a first fixed-voltage power supply 216 that produces current at a first fixed voltage V1 on voltage rail 210, a second fixed-voltage power supply 218 that produces current at a second fixed voltage V2 on voltage rail 212, and a third fixed-voltage power supply 220 that produces current at a third fixed voltage V3 on voltage rail 214. Although this exemplary embodiment includes three fixed-voltage power supplies 216-218, other embodiments may include any other number of such power supplies.

System 200 further includes power multiplexers 222, 224, 226 and 228. In this exemplary embodiment, power multiplexers 222-228 are 3:1 multiplexers, meaning that each has three power inputs and one power output. Nevertheless, in other embodiments such power multiplexers may have any other number of inputs. The power output of each of power multiplexers 222-228 is coupled to a power input of a corresponding PCD component. The power inputs of each of power multiplexers 222-228 are coupled to each of fixed-voltage power supplies 216-220 through voltage rails 210-214 in the same manner as in the embodiment described above with regard to FIG. 1.

Each of power multiplexers 222-228 also has a control or selector input. In the embodiment illustrated in FIG. 2, the control input of each of power multiplexers 222-228 receives a corresponding control signal 230, 232, 234 and 236, respectively, from a resource power manager 238. Resource power manager 238 produces control signals 230-236 in response to power supply voltage requests, which are included in component signals 240, 242, 244 and 246, respectively. Component signals 240-246 include all signals, messages, or other information communicated between the PCD components and resource power manager 238. As in the embodiment described above with regard to FIG. 1, each component in this embodiment may produce a power supply voltage request indicating a selected power level and thus corresponding to one of fixed-voltage power supplies 216-220. In the embodiment illustrated in FIG. 2, power multiplexers 222-228 receive control signals 230-236 directly from resource power manager 238. In other words, in this embodiment resource power manager 238 produces control signals 230-236 in response to power supply voltage requests produced by the PCD components, i.e., CPU 202, GPU 204, DSP 206 and memory system 208.

In response to receiving a power supply voltage request from a PCD component, resource power manager 238 may activate (i.e., turn on) the corresponding one of fixed-voltage power supplies 216-220 if it is not active at the time the power supply voltage request is received. In an instance in which resource power manager 238 activates one of fixed-voltage power supplies 216-220, resource power manager 238 may then communicate an acknowledgement indication or handshake to the requesting PCD component. If there are any one or more power levels (and corresponding fixed-voltage power supplies 216-220) for which resource power manager 238 does not receive a power supply voltage request from any of the PCD components, then resource power manager 238 may deactivate (i.e., turn off) any such non-requested ones of fixed-voltage power supplies 216-220.

In response to the control signals 230-236 received at their respective selector or control inputs, each of power multiplexers 222-228 selects one of voltage rails 210-214. Accordingly, the current and voltage characteristics supplied by a selected one of voltage rails 210-214 are coupled through the selecting one of power multiplexers 222-228 to the power input of the corresponding PCD component. Each PCD component that is selectively coupled to one of voltage rails 210-214 in this manner thus draws current through a selected one of voltage rails 210-214 and, correspondingly, from a selected one of fixed-voltage power supplies 216-220.

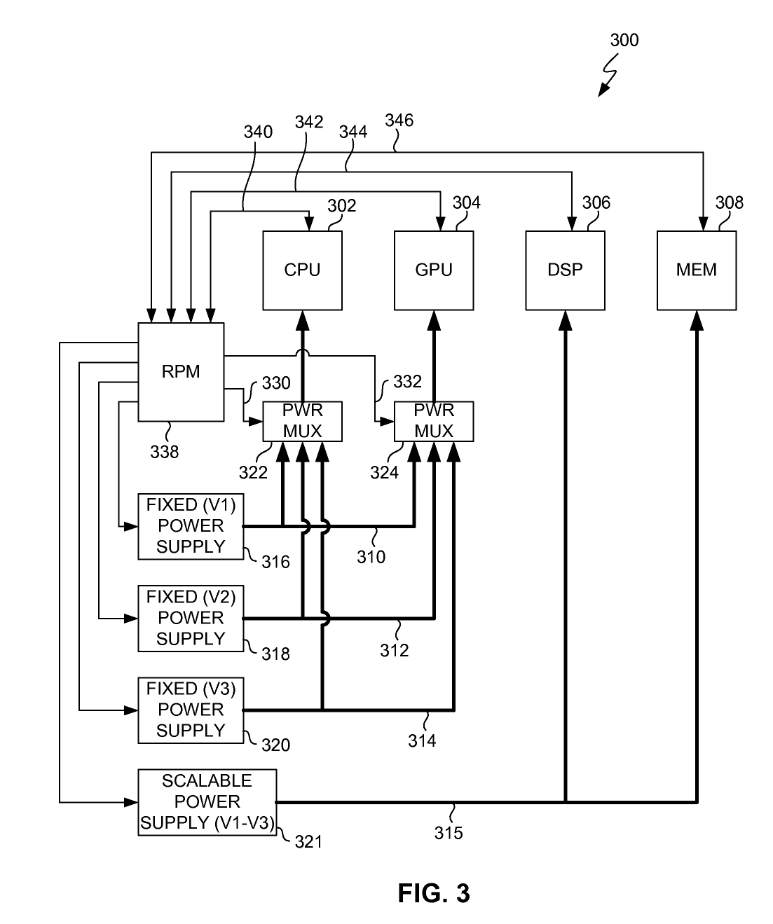

As illustrated in FIG. 3, in still another illustrative or exemplary embodiment, a system 300 for PCD power control includes a group of exemplary components: a CPU 302, a GPU 304, a DSP 306, and a memory system 308. In this embodiment, CPU 302 and GPU 304 receive power from a selected one of voltage rails 310, 312 and 314, while DSP 306 and memory system 308 may receive power from another voltage rail 315.

System 300 includes a first fixed-voltage power supply 316 that produces current at a first fixed voltage V1 on voltage rail 310, a second fixed-voltage power supply 318 that produces current at a second fixed voltage V2 on voltage rail 312, and a third fixed-voltage power supply 320 that produces current at a third fixed voltage V3 on voltage rail 314. In addition, system 300 includes a scalable-voltage power supply 321 that produces current at a selected voltage on voltage rail 315. Although this exemplary embodiment includes three fixed-voltage power supplies 316-318 that are coupleable to two PCD components and one scalable-voltage power supply 321 that is coupleable to two other PCD components, other embodiments may include any other number and combination of such fixed-voltage and scalable-voltage power supplies coupleable to any other number and combination of PCD components. In this embodiment, scalable-voltage power supply 321 may be controlled or adjusted by a resource power manager 338 to produce any selected one of voltages V1, V2 or V3. Nevertheless, in other embodiments such a scalable-voltage power supply may be configured to produce any other number and range of selectable voltages, including, for example, voltages different from those producible by the one or more fixed-voltage power supplies.

System 300 further includes power multiplexers 322 and 324, which are 3:1 multiplexers as in the embodiments described above with regard to FIGS. 1-2. Nevertheless, in other embodiments such power multiplexers may have any other number of inputs. The power output of power multiplexer 322 is coupled to a power input of one of the PCD components, such as CPU 302, while the power output of multiplexer 324 is coupled to a power input of another one of the PCD components, such as GPU 304. The power inputs of power multiplexers 322 and 324 are coupled to fixed-voltage power supplies 316-320 through voltage rails 310-314 in the same manner as in the embodiments described above with regard to FIGS. 1-2. Note, however, that in this embodiment that the power inputs of some of the PCD components, such as DSP 306 and memory system 308, are coupled directly to voltage rail 315 and are not coupled through any power multiplexer.

As in the embodiment described above with regard to FIG. 2, each of power multiplexers 322 and 324 has a control or selector input that receives a corresponding control signal 330 and 332, respectively, from resource power manager 338. Resource power manager 338 produces control signals 330 and 332 in response to power supply voltage requests, which are included in component signals 340 and 342, respectively. As in the embodiments described above with regard to FIGS. 1-2, some components, such as CPU 302 and GPU 304, may produce a power supply voltage request indicating a selected power level and thus corresponding to one of fixed-voltage power supplies 316-320. Resource power manager 338 produces control signals 330 and 332 in response to power supply voltage requests. In response to control signals 330 and 332, each of power multiplexers 322 and 324 couples or selects one of voltage rails 310-314. However, unlike in the above-described embodiments, in this embodiment, one or more other components, such as DSP 306 and memory system 308, participate in a voting-based power control scheme.

In response to receiving a power supply voltage request from CPU 302 or GPU 304, resource power manager 338 may activate (i.e., turn on) the corresponding one of fixed-voltage power supplies 316-320 if it is not active at the time the power supply voltage request is received. In an instance in which resource power manager 338 activates one of the fixed-voltage power supplies 316-320, resource power manager 338 may then communicate an acknowledgement or handshake to the requesting PCD component. If there are any one or more power levels (and corresponding fixed-voltage power supplies 316-320) for which resource power manager 338 does not receive a power supply voltage request from any of the PCD components, then resource power manager 338 may deactivate (i.e., turn off) any such non-requested ones of fixed-voltage power supplies 316-320.

In the voting-based power control scheme, two or more PCD components, such as DSP 306 and memory system 308 sharing the same power supply rail 315, may produce vote indications, which are included in component signals 344 and 346, respectively. The vote indications are similar to power supply voltage requests in that they indicate a selected one of the selectable power levels. For example, each of the vote indications may indicate a power level of V1, V2 or V3. However, resource power manager 338 handles vote indications differently than it handles power supply voltage requests. Specifically, resource power manager 338 identifies, among the received vote indications, the one indicating the highest selected power level. For example, in an instance in which a vote indication contained in component signal 344 indicates a power level of X volts and another vote indication contained in component signal 346 indicates a power level of Y volts, where Y is greater than X, then resource power manager 338 identifies the vote indication contained in component signal 346 as indicating the highest power level. It should be understood that power levels may be indicated in any units, such as volts, or in a unitless manner relative to each other (e.g., a low power level, a medium power level, and a high power level), or in any other manner.

Having identified the highest selected power level indicated, resource power manager 338 then adjusts scalable-voltage power supply 321 to produce a corresponding voltage, which may be referred to in this specification for convenience as a voted voltage. Thus, DSP 306 and memory system 308 both receive the voted voltage at their power inputs.

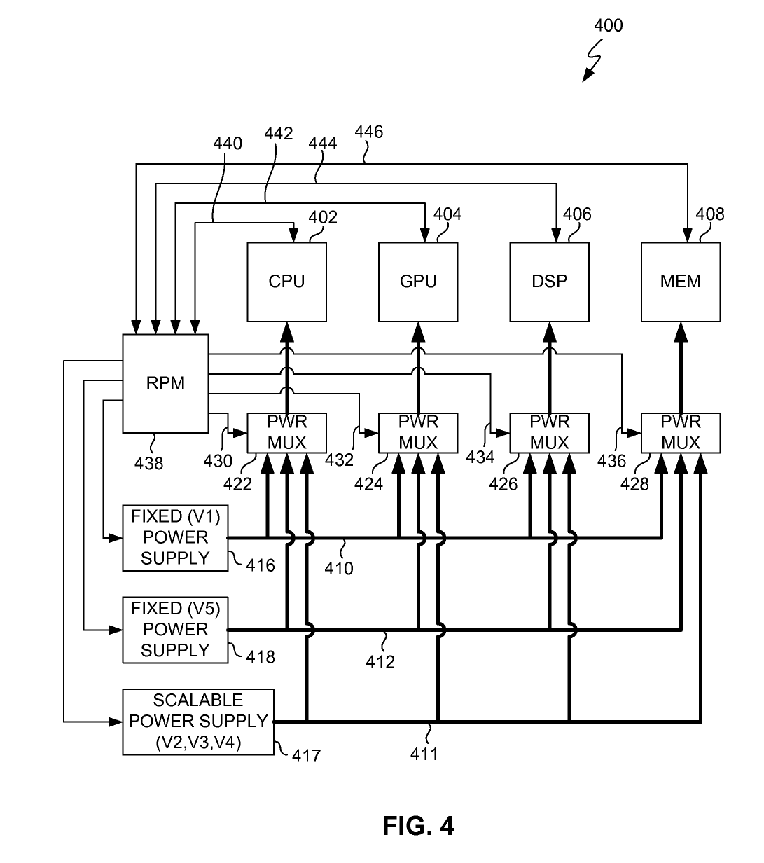

As illustrated in FIG. 4, in yet another illustrative or exemplary embodiment, a system 400 for PCD power control includes a group of exemplary components: a CPU 402, a GPU 404, a DSP 406, and a memory system 408. Although this exemplary embodiment includes four PCD components for illustrative purposes, other embodiments may include any other number of two or more PCD components. Each of these exemplary components may receive power from a selected one of three voltage rails 410, 412 and 411. System 400 includes a first fixed-voltage power supply 416 that produces current at a first fixed voltage, such as V1, on voltage rail 410, a second fixed-voltage power supply 418 that produces current at a second fixed voltage, such as V5, on voltage rail 412, and a scalable-voltage power supply 417 that produces current at a selected voltage on voltage rail 411. Although this exemplary embodiment includes two fixed-voltage power supplies 416 and 418 and one scalable-voltage power supply 417, other embodiments may include any other number and combination of such fixed-voltage and scalable-voltage power supplies coupleable to any other number and combination of PCD components. In this embodiment, scalable-voltage power supply 417 may be controlled by a resource power manager 438 to produce a selected one of V2, V3 or V4, while the remaining power levels V1 and V5 of the five exemplary power levels are produced by fixed-voltage power supplies 416 and 418. In this embodiment, the selectable power levels may consist of a closed set, such as V1, V2, V3, V4 and V5.

It should be understood that the power level scheme of exemplary system 400, in which there are two power levels (V1 and V5) out of five power levels (V1-V5) that are produced by fixed-voltage power supplies 416 and 418 while the remaining three power levels (V1, V2 and V3) are produced by a scalable-voltage power supply 417, is intended only for purposes of illustration. More generally, in such embodiments any one or more of the power levels in the set may be produced by one or more scalable-voltage power supplies, while any one or more other power levels in the set may be produced by one or more fixed-voltage power supplies.

System 400 further includes power multiplexers 422, 424, 426 and 428, which are 3:1 multiplexers as in the embodiments described above with regard to FIGS. 1-3. Nevertheless, in other embodiments such power multiplexers may have any other number of inputs. The power output of each of power multiplexers 422-428 is coupled to a power input of a corresponding PCD component. Two of the power inputs of each of power multiplexers 422-428 are coupled to fixed-voltage power supplies 416 and 418 through fixed-voltage rails 410 and 412, respectively. The third power input of each of power multiplexers 422-428 is coupled to scalable-voltage power supply 417 through voltage rail 411. In similar embodiments (not shown) having more than two power supplies, the power multiplexers would have corresponding numbers of power inputs.

Each PCD component of system 400, such as CPU 402, GPU 404, DSP 406 and memory system 408, may produce a component signal 440, 442, 444 and 446, respectively, which may be either a power supply voltage request or a vote indication. As described above with regard to FIG. 3, a vote indication represents a PCD component's vote for a power level to be shared with one or more other PCD components in accordance with a voting-based scheme, while a power supply voltage request represents a PCD component's request for a power level not necessarily to be shared with other PCD components. In this embodiment, whether a PCD component issues a power supply voltage request or a vote indication is determined by that PCD component. That is, a PCD component may elect to participate in a voting-based scheme, i.e., to be a member of a voting sub-group of the PCD components.

As in the embodiments described above with regard to FIGS. 2-3, each of power multiplexers 422, 424, 426 and 428 has a control or selector input that receives a corresponding control signal 430, 432, 434 and 436, respectively, from a resource power manager 438. However, in this embodiment resource power manager 438 produces control signals 430-436 in response to not only power supply voltage requests but also vote indications. That is, when resource power manager 438 receives a power supply voltage request from a PCD component, resource power manager 438 produces control signal 430, 432, 434 or 436 that causes the corresponding one of power multiplexers 422-428 to select either voltage rail 410 or voltage rail 412. However, when resource power manager 438 receives a vote indication from a PCD component, resource power manager aggregates the vote indication along with other vote indications received from other PCD components and identifies the vote indication among them indicating the highest selected power level, in the same manner described above with regard to FIG. 3. Having identified the highest selected power level indicated, resource power manager 438 then adjusts scalable-voltage power supply 417 to produce a corresponding “voted voltage.” Resource power manager 438 also produces one or more of control signals 430, 432, 434 and 436 that cause the corresponding ones of power multiplexers 422-428 to select scalable-voltage power supply 417 and voltage rail 411. Thus, those PCD components that participated in the voting-based scheme, i.e., components that are in the voting sub-group, receive the voted voltage at their power inputs, while those remaining PCD components that are not in the voting sub-group receive their requested voltages at their power inputs.

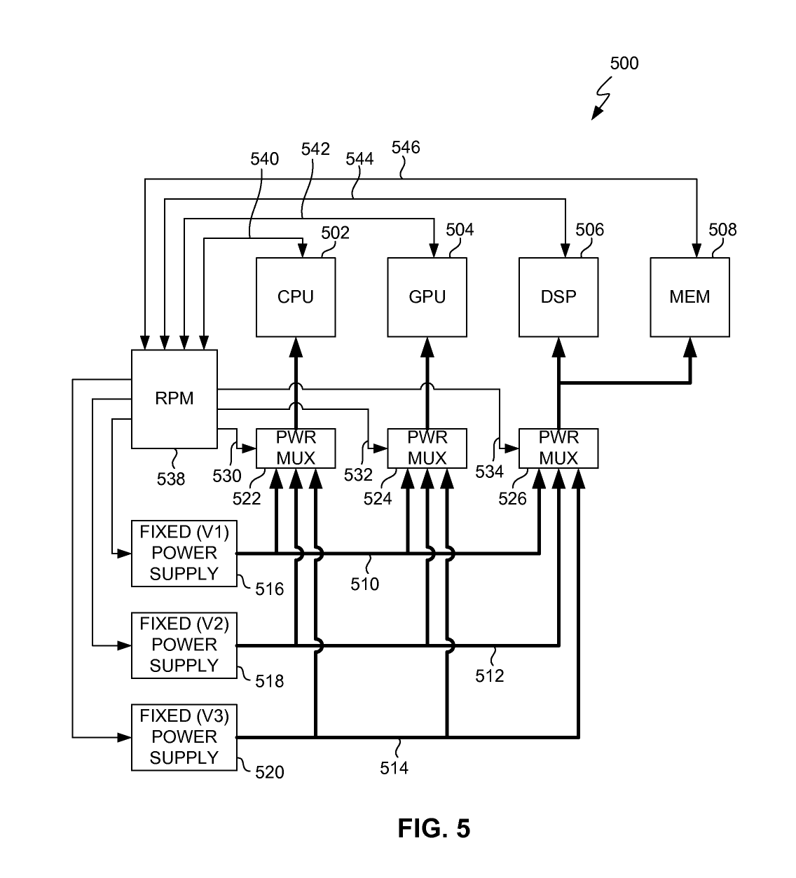

As illustrated in FIG. 5, in another illustrative or exemplary embodiment, a system 500 for PCD power control includes a group of exemplary PCD components: a CPU 502, a GPU 504, a DSP 506, and a memory system 508. Although this exemplary embodiment includes four PCD components for illustrative purposes, other embodiments may include any other number of two or more PCD components. Each of these four exemplary PCD components may receive power from a selected one of three exemplary voltage rails 510, 512 and 514.

System 500 also includes a first fixed-voltage power supply 516 that produces current at a first fixed voltage V1 on voltage rail 510, a second fixed-voltage power supply 518 that produces current at a second fixed voltage V2 on voltage rail 512, and a third fixed-voltage power supply 520 that produces current at a third fixed voltage V3 on voltage rail 514. Although this exemplary embodiment includes three fixed-voltage power supplies 516-520, other embodiments may include any other number of such power supplies.

System 500 further includes power multiplexers 522, 524 and 526, which are 3:1 multiplexers as in embodiments described above. Nevertheless, in other embodiments such power multiplexers may have any other number of inputs. The power output of each of power multiplexers 522-526 is coupled to a power input of a corresponding PCD component. However, note that in this embodiment the power inputs of DSP 506 and memory system 508 are both coupled to the same power multiplexer 526. The power inputs of each of power multiplexers 522-526 are coupled to each of fixed-voltage power supplies 516-520 through voltage rails 510-514 in the same manner as in embodiments described above.

As in embodiments described above, each of power multiplexers 522-526 also has a control or selector input. The control input of each of power multiplexers 522-526 receives a corresponding control signal 530, 532 and 534, respectively, from a resource power manager 538. As in embodiments described above, some components, such as CPU 302 and GPU 304, may produce a power supply voltage request indicating a selected power level and thus corresponding to one of fixed-voltage power supplies 516-520. Resource power manager 538 produces control signals 530 and 532 in response to power supply voltage requests. In response to control signals 530 and 532, each of power multiplexers 522 and 524 couples or selects one of voltage rails 510-514. However, in this embodiment, one or more other components, such as DSP 306 and memory system 308, participate in a voting-based power control scheme similar to that described above with regard to FIG. 3, except that in this embodiment the voting PCD components, such as DSP 506 and memory system 508, share the output of power multiplexer 526.

Resource power manager 538 may activate a corresponding one of fixed-voltage power supplies 516-520 in response to receiving a power supply voltage request from CPU 502 or GPU 504 (or if one of fixed-voltage power supplies 516-520 corresponds to a voted voltage) if such one of fixed-voltage power supplies 516-520 is not already active. In an instance in which resource power manager 538 activates one of the fixed-voltage power supplies 516-520, resource power manager 538 may then communicate an acknowledgement or handshake to the requesting or voting PCD component. If there are any one or more power levels for which resource power manager 538 does not receive a power supply voltage request or which are not voted voltages, then resource power manager 538 may deactivate any such non-requested and non-voted ones of fixed-voltage power supplies 516-520.

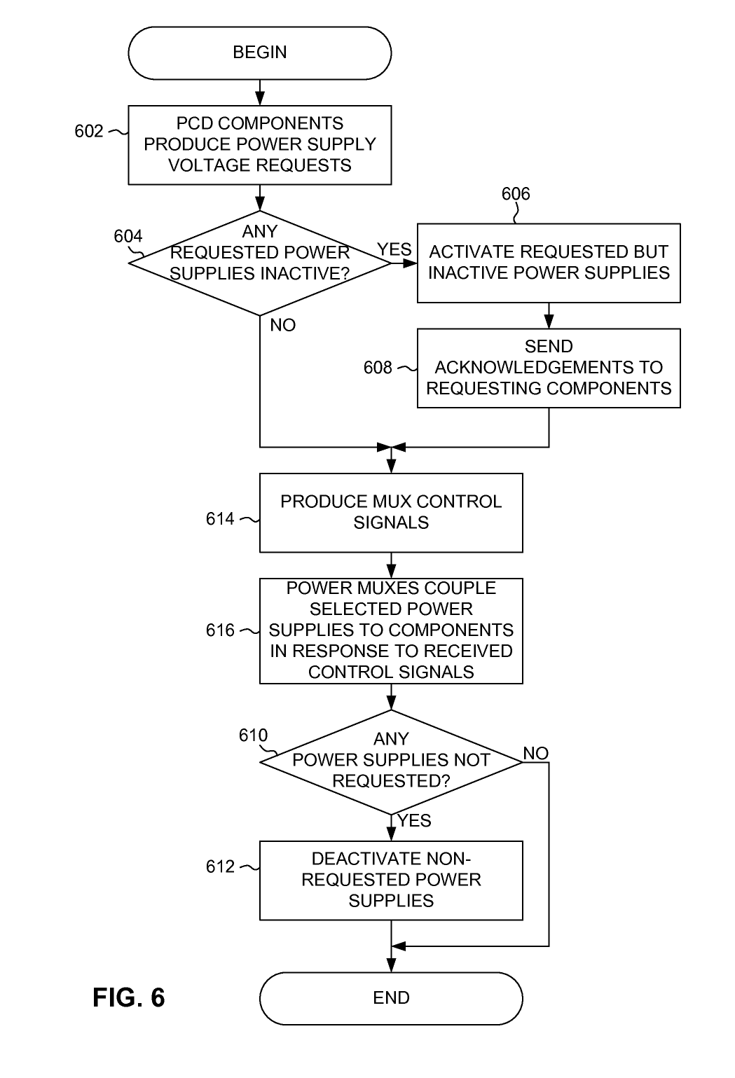

In this embodiment, two or more PCD components, such as DSP 506 and memory system 508, sharing the same power multiplexer 526, may produce vote indications, which are included in component signals 544 and 546, respectively. Each of the vote indications may indicate a power level of V1, V2 or V3. As in the embodiment described above with regard to FIG. 3, resource power manager 538 identifies, among the received vote indications, the one indicating the highest selected power level. Having identified the highest selected power level indicated, i.e., the voted voltage, resource power manager 538 then produces control signals 534 in response to the voted voltage. In response to control signals 534, power multiplexer 526 couples or selects one of voltage rails 510-514 corresponding to the voted voltage. Thus, DSP 506 and memory system 508 both receive the voted voltage at their power inputs. In the exemplary embodiments, the above-described methods for power control may be effected through logic with which the PCD and portions thereof, such as a resource power manager and PCD components, are configured. Such logic may be represented by the method described below with regard to FIG. 6. In view of the following descriptions, one of ordinary skill in the art readily will be capable of generating or otherwise providing such logic. The logic may be embodied in any form, including forms commonly referred to as software, firmware, programmable logic, etc. As used in this specification, the term “software” encompasses processor-executable code or instructions. Although not separately shown for purposes of clarity, a resource power manager may include a processor controlled in part by such logic. The logic may be stored in a memory in the resource power manager, PCD component, or other portion of the PCD. It should be noted that a combination of a non-transitory computer-readable storage medium and the computer-executable code or instructions stored therein for execution by a processor defines a “computer program product” as that term is understood in the patent lexicon. Furthermore, a PCD, resource power manager, or one or more PCD components, as programmed or configured with such logic or instructions, may serve as a “means” for performing one or more of the method steps or device functions described herein.

Although certain acts or steps in the methods described below naturally precede others for the exemplary embodiments to operate as described, the invention is not limited to the order of those acts or steps if such order or sequence does not alter the functionality of the invention. That is, it is recognized that some acts or steps may be performed before, after, or in parallel (i.e., substantially simultaneously) with other acts or steps without departing from the scope and spirit of the invention. In some instances, certain acts or steps may be omitted or not performed, without departing from the scope and spirit of the invention. Further, words such as “thereafter,” “then,” “next,” etc., are not intended to limit the order of the acts or steps. Rather, such words are used to aid in guiding the reader through the descriptions of the exemplary methods.

An exemplary method for power control is illustrated by a flow diagram in FIG. 6. Although not shown for purposes of clarity, the method may begin or be triggered when an event occurs that satisfies criteria for a component to operate at a higher or lower voltage than that at which it is operating at the time the event occurs. Each time such an event occurs, the method may be performed. A resource power manager or other device may monitor PCD operating conditions for the occurrence of such an event.

As indicated by block 602, two or more PCD components produce the above-described power supply voltage requests. In some embodiments, other PCD components may also produce the above-described vote indications. As indicated by block 604, it is determined whether any of the requested power supplies is currently inactive. If it is determined (block 604) that one or more of the requested power supplies are currently inactive, then the requested power supplies are activated, as indicated by block 606. When a requested power supply has been activated and ready for use by the requesting component, an acknowledgement may be sent to the requesting component, as indicated by block 608. After a PCD component has issued a power supply voltage request, the PCD component may temporarily enter a soft start mode to reduce transient power or perform other interim actions. Then, after the PCD component has received the acknowledgement, the PCD component may complete its transition to the requested power level.

As indicated by block 614, the above-described control signals are produced in response to the power supply voltage requests. As indicated by block 616, each power multiplexer responds to a control signal by selecting one of its inputs, thereby coupling the corresponding voltage rail to the requesting component.

As indicated by block 610, it is determined whether there are any power supplies that are not requested. If it is determined (block 610) that there are one or more power supplies that are not requested, then the non-requested power supplies are deactivated, as indicated by block 612. Although in the exemplary embodiment power supplies are activated and deactivated on an as-needed basis as described above, in other embodiments one or more of the power supplies may remain in an active or “on” state regardless of whether they are requested.

Although not shown in FIG. 6 for purposes of clarity, the power control method may be combined with a voting-based power control method, as described above with regard to FIG. 3. Also, although not shown in FIG. 6 for purposes of clarity, the power control method may further include some or all PCD components selecting whether to alternatively participate in a voting-based method, as described above with regard to FIGS. 4 and 5. In the embodiment described above with regard to FIG. 4, a portion or subset of a closed set of selectable power levels may be provided by one or more fixed-voltage power supplies, while the remaining portion or subset may be provided by one or more scalable-voltage power supplies in response to voting. In the embodiment described above with regard to FIG. 5, two or more PCD components participate in a voting-based method in which the voted voltage is provided those PCD components by one of the fixed-voltage power supplies through a shared one of the power multiplexers. Still other combinations of the systems and methods described above readily will occur to one of ordinary skill in the art in view of the descriptions in this specification.

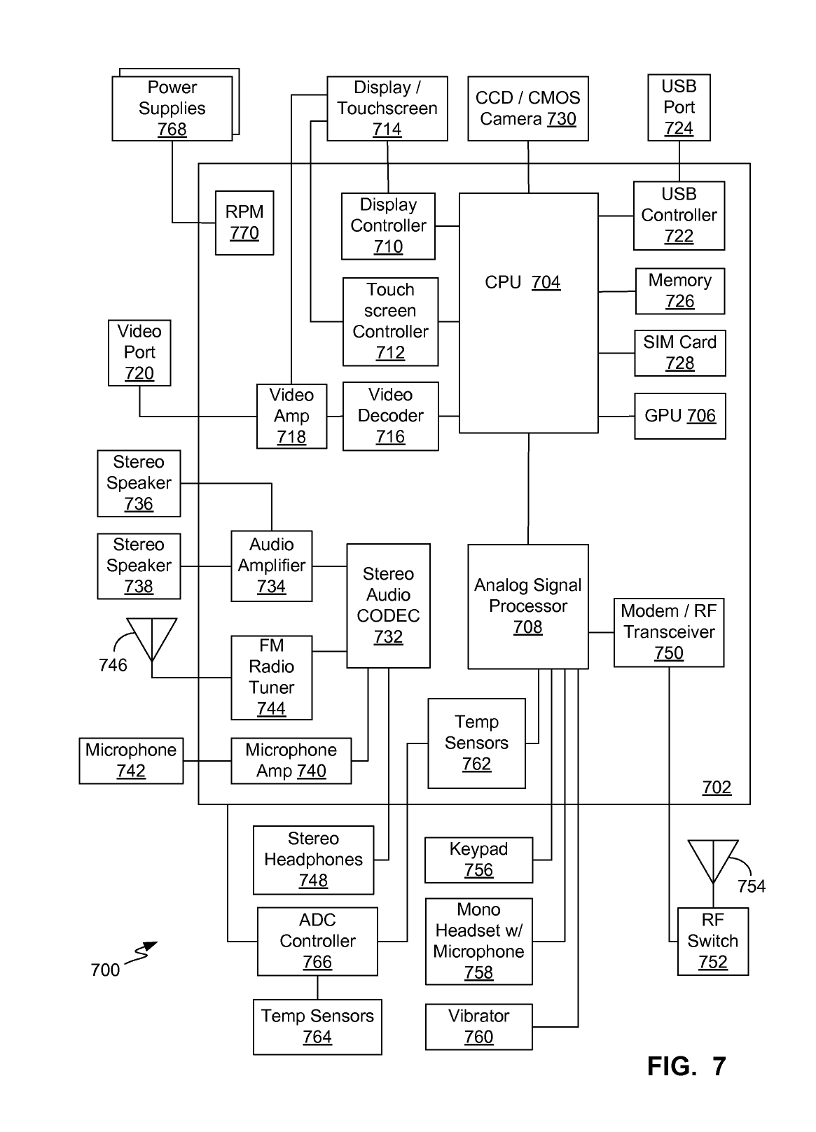

As illustrated in FIG. 7, in an illustrative or exemplary embodiment, a PCD 700 may be a mobile telephone. PCD 700 includes an on-chip system 702, i.e., a system embodied in an integrated circuit chip.

In PCD 700, the processors of on-chip system 702 include a central processing unit (“CPU”) 704 and a graphics processing unit (“GPU”) 706. PCD 700 also includes an analog signal processor 708. Note that CPU 704 and GPU 706 may serve as any of the CPUs and GPUs, respectively, described above with regard to FIGS. 1-5.

A display controller 710 and a touchscreen controller 712 are coupled to CPU 704. A touchscreen display 714 external to on-chip system 702 is coupled to display controller 710 and touchscreen controller 712. PCD 700 may further include a video decoder 716. Video decoder 716 is coupled to CPU 704. A video amplifier 718 is coupled to video decoder 716 and touchscreen display 714. A video port 720 is coupled to video amplifier 718. A universal serial bus (“USB”) controller 722 is also coupled to CPU 704, and a USB port 724 is coupled to USB controller 722. A memory 726, which may serve as any of the memory systems described above with regard to FIGS. 1-5, is coupled to CPU 704. A subscriber identity module (“SIM”) card 728 may also be coupled to CPU 704. In addition, a digital camera 730 may be coupled to CPU 704.

A stereo audio CODEC 732 may be coupled to analog signal processor 708. Further, an audio amplifier 734 may be coupled to stereo audio CODEC 732. First and second stereo speakers 736 and 738, respectively, may be coupled to audio amplifier 734. In addition, a microphone amplifier 740 may be also coupled to stereo audio CODEC 732, and a microphone 742 may be coupled to microphone amplifier 740. A frequency modulation (“FM”) radio tuner 744 may be coupled to stereo audio CODEC 732. An FM antenna 746 is coupled to the FM radio tuner 744. Further, stereo headphones 748 may be coupled to stereo audio CODEC 732.

A modem or radio frequency (“RF”) transceiver 750 may be coupled to analog signal processor 708. An RF switch 752 may be coupled to RF transceiver 750 and an antenna 754. In addition, a keypad 756, a mono headset with a microphone 758, and a vibrator device 760 may be coupled to analog signal processor 708. Internal and external temperature sensors 762 and 764, respectively, maybe coupled to an analog-to-digital conversion (“ADC”) controller 766.

Two or more power supplies 768, which may serve as any of the power supplies described above with regard to FIGS. 1-5, are coupled to on-chip system 702. A resource power manager 770 of the type described above with regard to FIGS. 2-5 may be included in on-chip system 702. In addition to being configured in the manner described above, resource power manager 770 may be configured to perform conventional resource power manager functions, as understood by one of ordinary skill in the art. Other power control and distribution elements, such as the above-described power multiplexers and voltage rails, are not shown in FIG. 7 for purposes of clarity.

Alternative embodiments will become apparent to one of ordinary skill in the art to which the invention pertains without departing from its spirit and scope. Therefore, although selected aspects have been illustrated and described in detail, it will be understood that various substitutions and alterations may be made therein without departing from the spirit and scope of the present invention, as defined by the following claims.

What is claimed is:

1. A method for power control in a portable computing device (“PCD”), the method comprising:
producing, by each of a plurality of PCD components, one of a plurality of power supply voltage requests, each power supply voltage request indicating one of a plurality of selectable power levels and corresponding to one of a plurality of fixed-voltage power supplies;
receiving, at each of a plurality of power multiplexers, a control signal in response to one of the power supply voltage requests; and
coupling a selected voltage produced by one of a plurality of fixed-voltage power supplies through each of the plurality of power multiplexers to a corresponding PCD component in response to the control signal.

2. The method of claim 1, further comprising:
receiving, at a resource power manager, the plurality of power supply voltage requests from the plurality of PCD components; and
issuing, from the resource power manager, the control signal to each of the plurality of power multiplexers.

3. The method of claim 2, further comprising:
activating, by the resource power manager, a first power supply of the plurality of fixed-voltage power supplies in response to receiving a power supply voltage request indicating a selected power level corresponding to the first power supply; and
deactivating, by the resource power manager, a second power supply of the plurality of fixed-voltage power supplies in response to not receiving a power supply voltage request indicating a selected power level corresponding to a second power supply.

4. The method of claim 3, further comprising producing, by the resource power manager, an acknowledgement indication after activating the first power supply.

5. The method of claim 2, further comprising:
producing a vote indication by each of another plurality of PCD components, the vote indication indicating one of the plurality of selectable power levels;
identifying, by the resource power manager, a highest selected power level indicated among a plurality of received vote indications;
adjusting, by the resource power manager, a scalable-voltage power supply to produce a voted voltage corresponding to the highest selected power level; and
receiving the voted voltage at each PCD component of the another plurality of PCD components.

6. The method of claim 2, further comprising:
producing a vote indication by each of a voting sub-group of the plurality of PCD components, the vote indication indicating one of the plurality of selectable power levels, wherein each of the plurality of PCD components not in the voting sub-group produces one of the plurality of power supply voltage requests;
identifying, by the resource power manager, a highest selected power level indicated among a plurality of received vote indications;
adjusting, by the resource power manager, a scalable-voltage power supply to produce a voted voltage corresponding to the highest selected power level and different than a voltage produced by any of a plurality of fixed-voltage power supplies; and
receiving, at each PCD component of the voting sub-group, the voted voltage through a corresponding one of the plurality of power multiplexers;
wherein the step of coupling a selected voltage comprises coupling a selected voltage produced by one of the plurality of fixed-voltage power supplies through each of the plurality of power multiplexers to a corresponding PCD component not in the voting sub-group.

7. The method of claim 1, wherein at least one of the plurality of PCD components comprises a system-on-chip core.

8. The method of claim 1, wherein the portable computing device comprises at least one of a mobile telephone, a personal digital assistant, a pager, a smartphone, a navigation device, and a hand-held computer with a wireless connection or link.

9. A system for power control in a portable computing device (“PCD”), the system comprising:
a plurality of PCD components, each PCD component configured to draw power in operation, each PCD component configured to produce one of a plurality of power supply voltage requests;
a plurality of fixed-voltage power supplies, each fixed-voltage power supply configured to produce a voltage different from a voltage produced by others of the plurality of fixed-voltage power supplies, each power supply voltage request indicating one of a plurality of selectable power levels and corresponding to one of the fixed-voltage power supplies; and
a plurality of power multiplexers, each power multiplexer coupled to a corresponding one of the plurality of PCD components and coupled to each of the plurality of fixed-voltage power supplies, each power multiplexer configured to receive a control signal in response to one of the power supply voltage requests, each power multiplexer configured to couple a selected voltage produced by one of the plurality of fixed-voltage power supplies through to a corresponding PCD component in response to the control signal.

10. The system of claim 9, further comprising a resource power manager configured to receive the plurality of power supply voltage requests from the plurality of PCD components, wherein the resource power manager issues the control signal to each of the plurality of power multiplexers.

11. The system of claim 10, wherein:
the resource power manager is configured to activate the first power supply in response to receiving a power supply voltage request indicating a selected power level corresponding to a first power supply of the plurality of fixed-voltage power supplies;
the resource power manager is configured to deactivate the second power supply in response to not receiving a power supply voltage request indicating a selected power level corresponding to a second power supply of the plurality of fixed-voltage power supplies.

12. The system of claim 11, wherein the resource power manager is configured to produce an acknowledgement indication after activating the first power supply.

13. The system of claim 10, further comprising:
another plurality of PCD components, wherein each of the another plurality of PCD components is configured to produce a vote indication, the vote indication indicating one of the plurality of selectable power levels;
wherein the resource power manager is configured to identify a highest selected power level indicated among a plurality of received vote indications;
wherein the resource power manager is configured to adjust a scalable-voltage power supply to produce a voted voltage corresponding to the highest selected power level than a voltage produced by any of a plurality of fixed-voltage power supplies; and
wherein each of the another plurality of PCD components is configured to receive the voted voltage.

14. The system of claim 10, wherein:
each of a voting sub-group of the plurality of PCD components is configured to produce a vote indication, the vote indication indicating one of the plurality of selectable power levels, wherein each of the plurality of PCD components not in the voting sub-group produces one of the plurality of power supply voltage requests;
the resource power manager is configured to identify a highest selected power level indicated among a plurality of received vote indications;
the resource power manager is configured to adjust a scalable-voltage power supply to produce a voted voltage corresponding to the highest selected power level and different than a voltage produced by any of a plurality of fixed-voltage power supplies;
each PCD component of the voting sub-group is configured to receive the voted voltage through a corresponding one of the plurality of multiplexers; and
each of the plurality of power multiplexers is configured to couple a selected voltage produced by one of the plurality of fixed-voltage power supplies through each of the plurality of power multiplexers to a corresponding PCD component not in the voting sub-group.

15. The system of claim 9, wherein at least one of the plurality of PCD components comprises a system-on-chip core.

16. The system of claim 9, wherein the portable computing device comprises at least one of a mobile telephone, a personal digital assistant, a pager, a smartphone, a navigation device, and a hand-held computer with a wireless connection or link.

17. A system for power control in a portable computing device (“PCD”), the system comprising:
means for producing one of a plurality of power supply voltage requests by each of a plurality of PCD components, each power supply voltage request indicating one of a plurality of selectable power levels and corresponding to one of a plurality of fixed-voltage power supplies;
means for receiving a control signal by each of a plurality of power multiplexers in response to one of the power supply voltage requests; and
means for coupling a selected voltage produced by one of a plurality of fixed-voltage power supplies through each of the plurality of power multiplexers to a corresponding PCD component in response to the control signal.

18. The system of claim 17, further comprising:
means for receiving, at a resource power manager, the plurality of power supply voltage requests from the plurality of PCD components; and
means for issuing, from the resource power manager, the control signal to each of the plurality of power multiplexers.

19. The system of claim 18, further comprising:
means for activating, by the resource power manager, the first power supply in response to receiving a power supply voltage request indicating a selected power level corresponding to a first power supply of the plurality of fixed-voltage power supplies; and
means for deactivating, by the resource power manager, the second power supply in response to not receiving a power supply voltage request indicating a selected power level corresponding to a second power supply of the plurality of fixed-voltage power supplies.

20. The system of claim 19, further comprising means for producing, by the resource power manager, an acknowledgement indication after activating the first power supply.

21. The system of claim 18, further comprising:
means for producing a vote indication by each of another plurality of PCD components, the vote indication indicating one of the plurality of selectable power levels;
means for identifying, by the resource power manager, a highest selected power level indicated among a plurality of received vote indications;
means for adjusting, by the resource power manager, a scalable-voltage power supply to produce a voted voltage corresponding to the highest selected power level; and
means receiving the voted voltage at each of the another plurality of PCD components.

22. The system of claim 18, further comprising:
means for producing a vote indication by each of a voting sub-group of the plurality of PCD components, the vote indication indicating one of the plurality of selectable power levels, wherein each of the plurality of PCD components not in the voting sub-group produces one of the plurality of power supply voltage requests;
means for identifying, by the resource power manager, a highest selected power level indicated among a plurality of received vote indications;
means for adjusting, by the resource power manager, a scalable-voltage power supply to produce a voted voltage corresponding to the highest selected power level and different than a voltage produced by any of a plurality of fixed-voltage power supplies; and
means for receiving, by each PCD component of the voting sub-group, the voted voltage through a corresponding one of the plurality of multiplexers;
wherein the means for coupling a selected voltage comprises means for coupling a selected voltage produced by one of the plurality of fixed-voltage power supplies through each of the plurality of power multiplexers to a corresponding PCD component not in the voting sub-group.

23. The system of claim 17, wherein at least one of the plurality of PCD components comprises a system-on-chip core.

24. The system of claim 17, wherein the portable computing device comprises at least one of a mobile telephone, a personal digital assistant, a pager, a smartphone, a navigation device, and a hand-held computer with a wireless connection or link.

25. A computer program product for power control in portable computing device (“PCD”), the computer program product comprising processor-executable logic embodied in at least one non-transitory storage medium, execution of the logic by one or more processors of the PCD configuring the PCD to:
produce, by each of a plurality of PCD components, one of a plurality of power supply voltage requests, each power supply voltage request indicating one of a plurality of selectable power levels and corresponding to one of a plurality of fixed-voltage power supplies;
receive at each of a plurality of power multiplexers a control signal in response to one of the power supply voltage requests; and
couple a selected voltage produced by one of a plurality of fixed-voltage power supplies through each of the plurality of power multiplexers to a corresponding PCD component in response to the control signal.

26. The computer program product of claim 25, wherein execution of the logic by one or more processors of the PCD further configures the PCD to:
receive, at a resource power manager, the plurality of power supply voltage requests from the plurality of PCD components; and
issue, from the resource power manager, the control signal to each of the plurality of power multiplexers.

27. The computer program product of claim 26, wherein execution of the logic by one or more processors of the PCD further configures the PCD to:
activating, by the resource power manager, the first power supply in response to receiving a power supply voltage request indicating a selected power level corresponding to a first power supply of the plurality of fixed-voltage power supplies; and
deactivate, by the resource power manager, the second power supply in response to not receiving a power supply voltage request indicating a selected power level corresponding to a second power supply of the plurality of fixed-voltage power supplies.

28. The computer program product of claim 27, wherein execution of the logic by one or more processors of the PCD further configures the PCD to produce, by the resource power manager, an acknowledgement indication after activating the first power supply.

29. The computer program product of claim 26, wherein execution of the logic by one or more processors of the PCD further configures the PCD to:
produce, by each of another plurality of PCD components, a vote indication, the vote indication indicating one of the plurality of selectable power levels;
identify, by the resource power manager, a highest selected power level indicated among a plurality of received vote indications;
adjust, by the resource power manager, a scalable-voltage power supply to produce a voted voltage corresponding to the highest selected power level; and
receive the voted voltage at each PCD component of the another plurality of PCD components.

30. The computer program product of claim 26, wherein execution of the logic by one or more processors of the PCD further configures the PCD to:
produce, by each of a voting sub-group of the plurality of PCD components, a vote indication indicating one of the plurality of selectable power levels, wherein each of the plurality of PCD components not in the voting sub-group produces one of the plurality of power supply voltage requests;
identify, by the resource power manager, a highest selected power level indicated among a plurality of received vote indications;
adjust, by the resource power manager, a scalable-voltage power supply to produce a voted voltage corresponding to the highest selected power level and different than a voltage produced by any of a plurality of fixed-voltage power supplies; and
receive, at each PCD component of the voting sub-group, the voted voltage through a corresponding one of the plurality of multiplexers;
wherein the PCD is configured to couple a selected voltage by being configured to couple a selected voltage produced by one of the plurality of fixed-voltage power supplies through each of the plurality of power multiplexers to a corresponding PCD component not in the voting sub-group.
